(19) United States
(12) Patent Application Publication
(10) Pub. No.: US 2002/0110244 A1
(43) Pub. Date: Aug. 15, 2002

(54) Key management system and method

(76) Inventors: Francis Flanagan, Dublin (IE); Iain Craig, Dublin (IE)

Correspondence Address: JACOBSON HOLMAN PLLC, 400 SEVENTH STREET N.W., SUITE 600, WASHINGTON, DC, 20004, US

(21) Appl. No.: 10/068,889

(22) Filed: Feb. 11, 2002

Related U.S. Application Data
(60) Provisional application No. 60/267,705, filed on Feb. 12, 2001.

(51) Int. Cl. H04L 9/00

(52) U.S. Cl. 380/277

(57) ABSTRACT

Keys for encryption are stored by a key server software database file system. There is separate and individual security for each key with per-key encryption. An alias makes a request to create a key, and the server requests an accelerator to generate the key, and subsequently receives it and stores it in a database.

### FIELD OF THE INVENTION

The invention relates to authentication of persons sending messages.

### PRIOR ART DISCUSSION

At present the digital signature mechanism provides such authentication, using cryptographic keys.

The secure long-term storage of cryptographic keys is an accepted problem. By their very nature, keys should not be accessed by anyone who is not properly authorised. The generally accepted best solution is to store keys in special-purpose hardware. This solution suffers from the flaw that such hardware stores are of fixed size and so extending their capacity requires physical modification to the store.

It is therefore an object of the invention to provide for safe storage of keys using a conventional storage system.

### SUMMARY OF THE INVENTION

According to the invention, there is provided a method for storing keys for authentication or encryption, the method being carried out by a host system, and comprising the steps of:

the host system operating as a key server controlling storage of the keys in a software database file system.

In one embodiment, the key server manages separate and individual security for each key with per-key encryption.

In another embodiment, the key server associates a set of keys with an alias, and each alias has an associated pass phrase.

In a further embodiment, a request to create a key is made by an alias, the server causes a key to be generated by a cryptographic accelerator, and stores the key in the database.

In one embodiment, the key server signs and hashes all files, and then hashes them to signed and encrypted files.

In another embodiment, aliases identify key rings which hold keys and certificates associated with the alias.

Preferably, each key ring is an indexed structure.

In one embodiment, each key ring allows access to certificate descriptions which refer to files and contain information on inception, dates, expiry dates, and creation dates.

In another embodiment, the key server, upon deletion of a key, spawns a thread which writes zeros or random numbers into a file which contains the key to overwrite the key.

In a further embodiment, over-writing is performed a configurable, plurality of times.

In one embodiment, the accelerator creates a meta key (K_{M}) and a salt (S) for access to the key server.

In another embodiment, the key server negotiates a session key (K_{S}) with the accelerator for a session, and the session key is deleted for a session.

In another embodiment, the key server uses the session key to encrypt data (R_{C}) associated with a key-creation request, and transmits the encrypted data to the accelerator.

In a further embodiment, the management system manages a private key (K_{P}) of a public/private key pair as follows:

the accelerator hashes a pass phase P with a salt S to produce a per-key encryption key K_{K};

the accelerator encrypts K_{P} with K_{K};

the accelerator encrypts the result with additional data K_{M}, and

the accelerator returning the result to the key server.

In one embodiment, the key server allows access to keys only if the requesting user is already associated with a stored key.

In another embodiment, the management system carries out the following steps upon receiving a request from an alias for use of an existing key:

(a) the initial request is expressed in terms of P;

(b) the encrypted key is retrieved from the key store and this is combined with P to form a request structure, Rᵤ;

(c) Rᵤ is encrypted with K_{S} and is transmitted to the accelerator;

(d) the accelerator decrypts Rᵤ using K_{S};

(e) the key is decrypted with K_{M};

(f) the passphrase from the request is hashed with S to give K_{K}; and

(g) the result from step (e) is decrypted with K_{K} to give K_{P}, the original key.

In one embodiment, the key sever encrypts each key using a meta key associated with an accelerator, whereby a plurality of accelerators may use the key server.

According to another aspect, there is provided a key management system comprises means for implementing a method as described above.

### DETAILED DESCRIPTION OF THE INVENTION

The invention will be more clearly understood from the following description of some embodiments thereof, given by way of example only.

A system and process for safe storage of encryption keys is described. The system comprises the following.

A host computer with a file system;

A cryptographic accelerator;

A device driver to enable communication between the host computer and the cryptographic accelerator. A “daemon” software function manages message exchange between processes by the device driver;

A key server executing on the host computer;

A shared library providing an application program interface (API) to the cryptographic accelerator and to the key server;

A management application that is used by a cryptographic officer/operator (user) in order to configure, monitor and control the provision of cryptographic services provided by the combination of the API, key server and cryptographic accelerator;

A number of terms and concepts must be introduced before the mechanism can be defined. Keys belong to aliases. Each alias “owns” a collection of keys; each key is intended to perform a specific function (encryption, decryption, signing, or verification). In order to gain access to the system as a whole, each alias must be assigned a pass phrase, a sequence of characters that should be of sufficient length to make guessing hard. Pass phrases are generalisations of passwords. They are used to provide a low-level form of authentication.

The keys are held in the key server, which is software to manage the creation, manipulation and use of keys. It is a server because it is intended to be accessible by multiple machines running applications requiring cryptographic functions, and by multiple cryptographic accelerators. The key server has mechanisms for indexing keys so that they can be easily retrieved and used when required. The server also contains management functions operating on information (“meta data”) about the keys it stores. In some cases the meta-data is sensitive and must be stored in a safe fashion and must, therefore, be encrypted. The key server must recognise this and treat such encrypted “red data” in a transparent and safe fashion.

The key server uses the host computer's file system to store the keys that it manages. This ensures that the upper bound on the number of keys that it is possible to store is far greater than it would be in any special purpose hardware storage mechanism. When a request to create a key is issued by an alias, the key server causes the key to be generated and then stores it in a file. When a request is made to retrieve a key (say, to perform encryption), the key data is retrieved from the file that contains it. The key server employs cryptographic techniques to ensure that the files it manages have not been corrupted or tampered with. It does this by signing all files and then hashing them to a special, encrypted and signed file. If the signatures do not match, the key server informs the cryptographic officer/operator who then has the opportunity to delete all files.

The key server's database is organised as a conventional tree structure. Aliases are used to identify key rings. Key rings hold the keys and certificates that are “owned” by the alias. Each key ring is an indexed structure that allows fast access to sets of key and certificate descriptions. The descriptions refer to the files in which the keys and certificates reside and also contain information on inception and expiry dates (if applicable), and creation date. The key server is implemented using object-oriented techniques, so that the meta-data associated with keys and certificates can easily be varied.

A single key server can serve multiple accelerators. The accelerators can have different meta keys. Meta keys are transparent to the key server for the reason that they are never visible beyond the boundary of the accelerator.

The key server is specified mathematically using Z notation. Proofs of correctness have been given and safety theorems have been proved in which relevant parts (those dealing with key transport and manipulation) of the accelerator are given a formal specification. The connection between the key server and the accelerator (the daemon) was also specified in sufficient detail to describe the movement of messages.

Cryptographic officers and operators do not have access to the contents of the files containing keys. As stated above, a key file can contain sensitive information about the key and this information should never be revealed to anyone other than the owner of the key. Only the owner of a key can access the contents of these files, as is described below.

Should a key ever be deleted, the key server spawns a thread. This thread writes zeroes or random numbers into the file that contained the key, thus over-writing the previously stored data. The entire file is over-written a number of times (that number being a configurable parameter-100 is the default) thus reducing the possibility of tempest-like attacks on disk surfaces.

The pass phrase (“P”) is used to authenticate access to and operations upon keys, as described below. The following relates to an embodiment in which there is a single cryptographic accelerator. This assists clarity without loss of generality.

When the cryptographic accelerator (henceforth, “accelerator”) is configured, it generates a meta key, K_{M} and a salt S. These are stored securely on an I-button. Access to the meta key and to the salt is either via a cryptographic officer/operator's pass phrase or a “know something, bring something” protocol.

Each time the key server opens a session with the accelerator, it negotiates a session key K_{S} that is maintained by both parties in a place that is accessible though still protected. When the session closes, the session key is deleted (the store it occupies in the key server need not be erased for that key will never be used again).

When a request is received to create a new private/public key pair (or a symmetric key), the request must be associated with a unique alias and a pass phrase P. The data associated with the request, R_{C}, is encrypted with K_{S} and sent to the accelerator. When the accelerator receives R_{C}, it decrypts it with K_{S}. The accelerator generates the key pair (or symmetric key). For a private key member, K_{P}, of a public/private key pair (which might contain CRT coefficients), the following occurs:

The accelerator hashes P with S to produce a per-key encryption key, K_{K};

The accelerator encrypts K_{P} with K_{K};

The accelerator encrypts the result with K_{M} (additional data available to the cryptographic officer can be added prior to this encryption, as can any red meta-data associated with the key);

The result is returned to the key server for storage.

As long as a user has at least one key in the key server's database, they can operate on keys. This is because the authentication scheme rests upon the existence of a previous key. For example, if an alias requests that an existing (private or symmetric) key be used, the following will occur:

1. The initial request is expressed in terms of P;

2. The encrypted key is retrieved from the key store. This is sent with P to form the request structure, Rᵤ;

3. The request, Rᵤ, is encrypted with K_{S} and is transmitted to the accelerator;

4. The accelerator decrypts Rᵤ using K_{S};

5. The key is decrypted with K_{M};

6. The passphrase from the request is hashed with S to give K_{K};

7. The result from step (5) above is decrypted with K_{K} to give K_{P}, the original key.

It is worth pointing out, although it should be clear, that an attempt to perform the above seven steps using P₁≠P yields unusable results.

A similar sequence of events occurs whenever any operation on a key is performed.

The key-creation algorithm involves per-key encryption prior to encryption with the meta key. Per-key encryption increases the security of each key. It ensures that the cryptographic officer is unable to access any keys other than their own as plaintext. They cannot do so because they do not have access to the passwords of any keys other than their own.

Every key in the system is also encrypted using a meta key for added security. The meta key facilitates extensibility of the system that uses it. It allows new accelerators to be added or old ones removed at any time. When new accelerators are added, key negotiation can occur between the new unit and the one that was previously connected in order to establish a new key. This also implies that a change of hardware becomes a simple matter, provided that, in the limit, at least one unit that was previously connected remains there while the new equipment is being connected. Once the new units have been connected and key exchange has taken place, the old unit can even be disconnected.

The system also acts against hardware failure. Since the metakey is not uniquely stored in one unit, should a subset of the units in a system fail, it is always possible to gain access to the metakey, and, hence, to the keys it has been used to encrypt.

The metakey scheme allows key databases to be validated. If, for example, it is suspected that one or more keys have been interfered with in some fashion, the metakey can simply be changed. In this circumstance, the database of keys can no longer be decrypted with the current metakey (which is not the one used to encrypt it) and is, therefore, invalid, with respect to the current metakey (which is the yardstick against which all validations occur). Furthermore, if one or more of the accelerator units connected to a host-but not all of them-fails, the keys in the database can still be validated by the metakey that is stored on the remaining unit or units. The validation process generalises to any database, not just a database containing keys.

Should an attempt be made to tamper with a unit's metakey (say by replacing it or ‘adjusting’ it in some way), that unit will no longer be able to validate keys. Indeed, it will no longer be able to engage successfully in many cryptographic operations for the reason that it will not be able to decrypt keys (assuming the metakey is symmetric). If meta keys are private-public pairs, tampering with the meta key on one unit has the implication that that unit will produce data that cannot be read by any other unit. This does not impact upon the overall performance of the system. However, the inability of one unit to decrypt data that has been encrypted by another should cause the system as a whole to react. Thus, an attack on the meta keys of a system requires that all units be attacked, or that a key exchange be forced upon them (which can be prevented but which produce meta keys that remain invisible to anything other than the software).

The scheme also is harder to crack than if a single key were employed to encrypt all keys. If only one key were used, once this unique key is compromised, so are all the keys that it has been used to encrypt. Under the per-key scheme, compromise of a single key has no effect upon the other keys in the store. Therefore, to gain access to all keys, all of the keys used to encrypt those keys need to be known.

The scheme provides for individual security for each individual key. Each key's security depends upon a key that is specific to it and that relates to no other entity in the cryptographic system.

Per-key encryption also affords more security than does retention and storage of keys as plaintext.

There are circumstances in which a change of meta key, K_{M}, is desirable. For example, the cryptographic officer might need to invalidate previous key server backups. A hardware failure might require that one accelerator be taken out of service and replaced by another. There might be a change in cryptographic officer. These cases require change of meta key. The process is performed as follows.

when the meta key is changed, we have the case in which there will be two meta keys, K_{M1} and K_{M2}; we assume that K_{M1} is the old meta key and K_{M2} is the new (replacement) one.

Normally, the keys in the key server's database will be encrypted with K_{M1}. When a meta key change occurs, the following will occur:

1. A request is made to change the meta key.

2. The accelerator generates a new meta key, K_{M2}.

3. Each key stored in the key server's database is sent to the accelerator. The accelerator decrypts it using the old meta key, K_{M1}, and then re-encrypts it using K_{M2}, the new meta key. The meta key select flag is toggled.

4. The key is returned to the key server which immediately stores it.

5. The entire key server database is backed up and the old meta key, K_{M1}, is invalidated.

This mechanism can also be employed to alter the association between keys and the accelerator on which they are processed. This allows keys to be exported from one accelerator to another; it also allows keys to be moved when an accelerator experiences a hardware fault.

The addition and removal of cryptographic accelerators is performed using the same meta key replacement mechanism. It can be described as follows:

1. The management application (the interface for the cryptographic officer/operator) is used to request an accelerator set reconfiguration.

2. The new set of accelerators negotiate a meta key between them using, for example, Diffie-Hellman key exchange protocol.

3. The new accelerators (if any) are flagged as being in a catch-up state and cannot be used until the key database update is complete.

4. The key database update is completed as described above.

5. The new units are flagged as online and available for use.

It will be appreciated that the invention provides the following advantageous features:

Additional cryptographic accelerators can be added to the system at any time.

Cryptographic accelerators can be removed from the system at any time.

Provided that more than one cryptographic accelerator forms part of the system at any time, hardware failure in any one of the accelerators does not require the invalidation of any keys.

Cryptographic officers/operators/system administrators are prevented from gaining access to keys and from performing certain operations on keys while the owners of keys are permitted access.

The invention permits the storage of many orders of magnitude more keys than do prior art hardware systems.

All and any backup of the key store can be invalidated by the cryptographic officer at any time.

The invention is not limited to the embodiments described but may be varied in construction and detail.

1. A method for storing keys for authentication or encryption, the method being carried out by a host system, and comprising the steps of:
the host system operating as a key server controlling storage of the keys in a software database file system.

2. A method as claimed in claim 1, wherein the key server manages separate and individual security for each key with per-key encryption.

3. A method as claimed in claim 1, wherein the key server associates a set of keys with an alias, and each alias has an associated pass phrase.

4. A method as claimed in claim 1, wherein a request to create a key is made by an alias, the server causes a key to be generated by a cryptographic accelerator, and stores the key in the database.

5. A method as claimed in claim 1, wherein the key server signs and hashes all files, and then hashes them to signed and encrypted files.

6. A method as claimed in claim 3, wherein aliases identify key rings which hold keys and certificates associated with the alias.

7. A method as claimed in claim 6, wherein each key ring is an indexed structure.

8. A method as claimed in claim 6, wherein each key ring allows access to certificate descriptions which refer to files and contain information on inception, dates, expiry dates, and creation dates.

9. A method as claimed in claim 1, wherein the key server, upon deletion of a key, spawns a thread which writes zeros or random numbers into a file which contains the key to overwrite the key.

10. A method as claimed in claim 9, wherein over-writing is performed a configurable, plurality of times.

11. A method as claimed in claim 4, wherein the accelerator creates a meta key (K_{M}) and a salt (S) for access to the key server.

12. A method as claimed in claim 4, wherein the key server negotiates a session key (K_{S}) with the accelerator for a session, and the session key is deleted for a session.

13. A method as claimed in claim 12, wherein the key server uses the session key to encrypt data (R_{C}) associated with a key-creation request, and transmits the encrypted data to the accelerator.

14. A method as claimed in claim 4, wherein the management system manages a private key (K_{P}) of a public/private key pair as follows:
the accelerator hashes a pass phase P with a salt S to produce a per-key encryption key K_{K};
the accelerator encrypts K_{P} with K_{K};
the accelerator encrypts the result with additional data K_{M}, and
the accelerator returning the result to the key server.

15. A method as claimed in claim 1, wherein the key server allows access to keys only if the requesting user is already associated with a stored key.

16. A method as claimed in claim 15, wherein the management system carries out the following steps upon receiving a request from an alias for use of an existing key:
(a) the initial request is expressed in terms of P;
(b) the encrypted key is retrieved from the key store, and this is combined with P to form a request structure, Rᵤ;
(c) Rᵤ is encrypted with K_{S} and is transmitted to the accelerator;
(d) the accelerator decrypts Rᵤ using K_{S};
(e) the key is decrypted with K_{M};
(f) the passphrase from the request is hashed with S to give K_{K}; and
(g) the result from step (e) is decrypted with K_{K} to give K_{P}, the original key.

17. A method as claimed in claim 4, wherein the key sever encrypts each key using a meta key associated with an accelerator, whereby a plurality of accelerators may use the key server.

18. A key management system comprising means for implementing a method as claimed in any preceding claim.

19. A computer program product comprising software code for performing the key server steps of claim 1 when executing on a digital computer.
